(19) United States
(12) Patent Application Publication
(10) Pub. No.: US 2011/0173570 A1
(43) Pub. Date: Jul. 14, 2011

(54) DATA FEEDS WITH PERIPHERALLY PRESENTED INTERESTING CONTENT

(75) Inventors: George Moromisato, Seattle, WA (US); Raman Narayanan, Bellevue, WA (US); Rajendra H. Vishnumurty, Bellevue, WA (US); Ming Liu, Redmond, WA (US); Matthew S. Augustine, Seattle, WA (US); Russell P. Songco, Seattle, WA (US)

(73) Assignee: Microsoft Corporation, Redmond, WA (US)

(21) Appl. No.: 12/686,577

(22) Filed: Jan. 13, 2010

(51) Int. Cl. G06F 3/048

(52) U.S. Cl. 715/838

(57) ABSTRACT

A social data feed, comprising a set of data items submitted by individuals in a social network, may be presented to the user, but the frequency of new data items appearing in the social data feed may be overwhelming, and may cause the user to miss data items that may be of interest. Instead, potentially interesting data items may be selected and peripherally presented to the user, e.g., as a tiled set of thumbnail images presented near the right edge of the display, adjusted for low contrast with the display background. Peripheral presentation may suggest potentially interesting data items to the user, thereby promoting serendipitous discovery of interesting data items, while reducing the distraction of the user while viewing the social data feed. Metadata of an interesting data item may be displayed upon user selection (e.g., pointer hovering), and interesting content items within a selected data item may be highlighted.

### BACKGROUND

Within the field of computing, many scenarios involve the presentation of a social data feed generated by a social networking social data source and comprising one or more data items. For example, a set of individuals known to a user may submit a set of news items, and the user may wish to read the set of news items for all such individuals; or the individuals may submit a set of media items, such as images, and the user may wish to examine the media items submitted by such individual. The social data feed may be presented to the user by obtaining from the social data source one or more data items, and displaying the data items on a device operated by a user, such as in a vertical column of entries that present or describe the respective data items of the social data feed. The data items may be sorted in various ways (e.g., by reverse chronology, by priority, or by predicted relevance to the user) and/or filtered according to various criteria (e.g., by filtering an event feed in order to view news updates of the social data feed that arise within a specified time range; by filtering a social news feed in order to view a subset of news items submitted by individuals of the social network that relate to a particular topic; or by filtering the social data feed according to a selected group of related users in order to view a subset of information about such users.)

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Some social data feeds may include a large set of data items, and may be frequently updated. Moreover, two or more social data feeds (such as a social news feed and a social photo feed) may be aggregated and presented to the user as an aggregated social data feed. However, it may be difficult for the user to review the volume, scope, and update frequency of the social data feed, particularly if the user follows an aggregate set of many social data feeds submitted by many individuals. The user may choose to filter the presented social data feeds in order to view a subset of social network data items that may be of greater interest to the user, but because the filtering may be based on comparatively general criteria (such as keywords or identified users), the filtering may arbitrarily remove some social network data items that might be interesting to the user. Consequently, the user may miss some social network data items that may be interesting due to the volume of monitored social data feeds.

Alternative techniques may be utilized to present data items of the social data feed to the user that improve the exposure to the user of potentially interesting data items. These techniques involve a selection of potentially interesting data items, according to various criteria (e.g., the types of the data items, data items relating to identified interests of the user, or data items related to other data items in which the user has expressed an interest), and a peripheral presentation of these selected data items to the user, e.g., presenting the selected data items as a grid adjacent to an edge of the social data feed. By peripherally presenting the selected data items to the user, these techniques may expose the user to more potentially interesting data items of the social data feed, without interfering with the user's review of the social data feed (which may be presented to the user in a focal position, such as near the center of the display.) In addition, the selected data items may be modestly de-emphasized, e.g., by presenting respective data items as a preview representation (such as a thumbnail of an image data item, or an excerpt or summary of a textual data item) that suggests the content of the selected data item while economizing display space, and/or by presenting the selected data item having a low contrast with a display background (e.g., by reducing the contrast of an image and by shifting the lightness or hue of the image toward the lightness or hue of the background.) According to these techniques, the peripheral presentation of the selected data items may promote the serendipitous discovery of data items of the social data feed that are interesting to the user, but that also comprises a comparatively subtle and low-interference presentation that reduces the user distraction while viewing the social data feed.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a presentation of a social data feed to a user.

FIG. 2 is an illustration of an exemplary scenario featuring a presentation of a social data feed to a user according to the techniques presented herein.

FIG. 3 is a flow chart illustrating an exemplary method of presenting to a user at least one data item of a social data feed.

FIG. 4 is a component block diagram illustrating an exemplary system for presenting to a user at least one data item of a social data feed.

FIG. 5 is an illustration of an exemplary computer-readable medium comprising processor-executable instructions configured to embody one or more of the provisions set forth herein.

FIG. 6 is an illustration of an exemplary scenario featuring a deployable computing environment represented as an object hierarchy on a set of devices forming a mesh.

FIG. 7 is an illustration of an exemplary scenario featuring a selection of data items that may be interesting to the user based on other data items and a user profile of the user.

FIG. 8 is an illustration of an exemplary scenario featuring a peripheral presentation of selected data items that may be interesting to the user.

FIG. 9 is an illustration of an exemplary scenario featuring an adjusting of a selected data item to be presented with low contrast with the background of a display of a device operated by the user.

FIG. 10 is an illustration of an exemplary scenario featuring a presentation of a metadata item for a preview representation of a selected data item, and a presentation of the selected data item.

FIG. 11 is an illustration of an exemplary scenario featuring a highlighting of content items in selected data items that may be interesting to the user.

FIG. 12 is an illustration of an exemplary scenario featuring an adjusting of the selection of data items according to user feedback provided by the user.

FIG. 13 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a presentation to a user of a social data feed, comprising a set of data items that relate to individuals who are known to the user. For example, particular individuals may publish content about themselves, including news and status updates, anecdotes, commentaries, and produced data objects, such as images, videos, and music. These individuals may offer such data items publicly, or may restrict the data items to a designated set of individuals, such as personal acquaintances of the individual or subscribers to a particular service. The user may identify a set of such individuals who the user wishes to “follow” by monitoring their social data feeds, and a device operated by the user (such as a desktop or portable computer, an internet appliance, or a smartphone) may request the data items (which may be hosted by one or more social data sources, such as a social network or a weblog host) published by these individuals and may present to the user a social data feed, comprising an aggregated set of data items providing social information about the individuals of interest to the user.

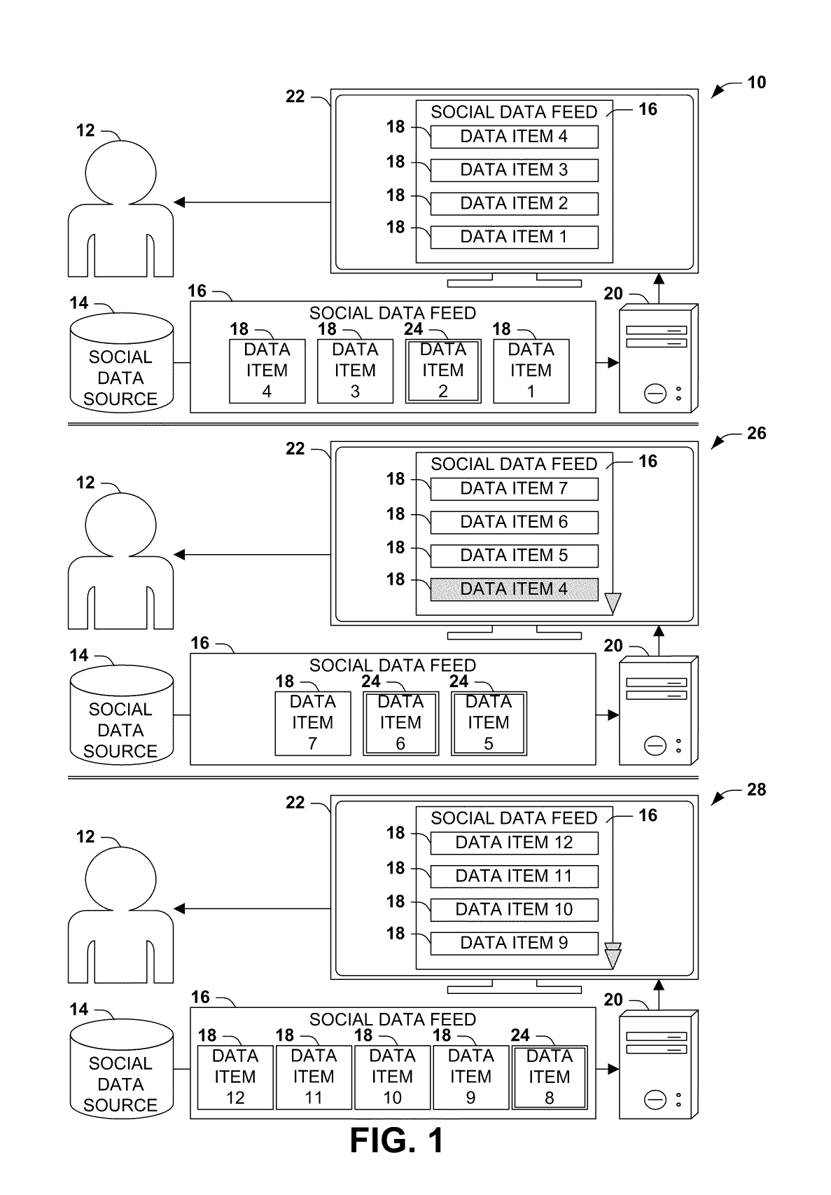

FIG. 1 presents an exemplary scenario featuring a user 12 requesting a social data feed 16 from a social data source 14. At a first time point 10, a user 12 may request to view the social data feed 16, and a device 20 of the user 12 (such as a computer) may request from the social data source 14 the data items 18 comprising the social data feed 16. Upon receiving some data items 18, the device 20 may render them on a display 22, e.g., as a vertical column of horizontally aligned data items 18. The data items 18 might be sorted, e.g., in reverse chronological order, such that the newest data items 18 are presented at the top of the column. The user 12 may review the data items 18, and may identify one or more interest data items 24, such as the second data item 18. Such interest might be manifested, e.g., by clicking on or hovering over the interesting data item 24, by viewing the interesting data item 24 in its entirety (if it is presented in a preview representation in the social data feed 16, e.g., as a thumbnail version of an image that may be selected to view the image at full resolution), or simply by spending more time looking at the interesting data item 24 than the other data items 18. In this manner, the user 12 may view the data items 18 of the social data feed 16 in order to find and consume interesting data items 24.

However, in some scenarios, it may be difficult for the user 12 to locate interesting data items 24 of the social data feed 16. For example, the social data feed 16 may be frequently updated with a large number of new data items 18, and the user 16 may not be able to examine the data items 18 at the pace with which they are presented. If the user 12 follows many individuals, the social data feed 16 may become too voluminous or rapid for the user 12 to examine every data item 18 in sufficient detail to identify the interesting data items 24. Indeed, the user 12 may not even be able to find a previously seen interesting data item 24 during a subsequent presentation of the social data feed 16 if too many new data items 24 have arrived in the interim. In FIG. 1, at a second time point 26, the user 12 may view a second presentation of the social data feed 16 (e.g., by refreshing a web page comprising the social data feed 16, or simply by continuing to view the web page while it is automatically supplemented with new data items 18.) The social data source 14 may provide the new data items 18 to the device 20 of the user 12, which may present them on the display 22 at the top of the column, thereby pushing the previously viewed data items 18 to lower positions (such as by displaying the fourth data item 18, which was also presented at the first time point 10, under the new data items 18 that have since been received from the social data source 14.) If the social data feed 16 continues to receive new data items 18 faster than the user 12 reviews the already presented data items 18, some interesting data items 24 may be missed. For example, at a third time point 28, the social data feed 16 may be presented with the latest data items 18 including an interesting data item 24 (the eighth data item), which may be buried underneath newer data items 18, and the user 12 may not even see the interesting data item 24 without vertically scrolling.

In order to promote the presenting of interesting data items 24, the user 12 may choose to filter the social data feed 16 in various ways, e.g., to select for viewing on the display 22 only data items 18 published by individuals of particular interest to the user 12, of data types that are of greater interest to the user 12 (e.g., data items 18 comprising photos may be more interesting to a user 12 than textual data items 18), or that contain keywords relating to particular topics of interest to the user 12. A set of such filters might be presented, and the user 12 may apply one or more to adjust the set of data items 18 presented in the social data feed 16. However, such filters may restrict out an interesting data item 24 that happens to not meet the criteria of the filter. For example, the user 12 may be interested in images of a particular event, such as the “National Conference,” and so may filter the social data feed 16 to present only data items 18 comprising photos that include “National Conference” in an attached text entry, such as the filename or caption of the photo. However, this filter may undesirably exclude data items 18 comprising photos that happen to not include the name of the event (e.g., “Me at the Conference!”), that use an acronym of the conference (e.g., “my photos from the NC!”), or that misspell the name of the conference (e.g., “Photos from the National Conferance”). Moreover, data items 18 may be of interest to the user 12 in various ways, but the user 12 may not even know of an interest (e.g., the user 12, having attended a particular conference, might be interested in data items 18 relating to another conference on the same subject of which the user is unaware); therefore, the user 12 may fail to specify criteria of a filter that might select these data items 18.

In view of these and other considerations, techniques may be developed to promote the presentation to the user of interesting data items 24 of a social data feed 16 that may have a large number of data items 18. It may be possible to perform an automated evaluation of the data items 18, and to identify data items 18 that may be interesting to the user 12 based on various criteria. Moreover, rather than filtering the social data feed 16 to present only the interesting data items 24, the interesting data items 24 may be presented in a manner supplemental to the presentation of the social data feed 16. However, it may be appreciated that an automated selection of interesting data items 24 might be inaccurate; e.g., the user might not actually find the potentially interesting data items 24 to be interesting (particularly if information about the interests of the user 12 is scant.) Therefore, it may be desirable to display the supplemental presentation in a comparatively subtle manner, so that the user 12 is not distracted from viewing the social data feed 16, but may notice some aspects of the data items 18 that may attract the interest of the user 12. For example, if the interesting data items 18 are presented peripherally on the display 22 with respect to the presentation of the social data feed 16, an aspect of such interesting data items 18 might catch the user's eye, such as a keyword, a name, an individual or subject presented in a photo, or an aesthetic quality of an image, while the user 12 is viewing the social data feed 16. The peripheral presentation of the interesting data items 24 may therefore promote the serendipitous discovery by the user 12 of interesting data items 24, even of data items 18, individuals, and topics that the user 12 might not have previously identified as interesting, while reducing the distraction of the user 12 in examining the social data feed 16.

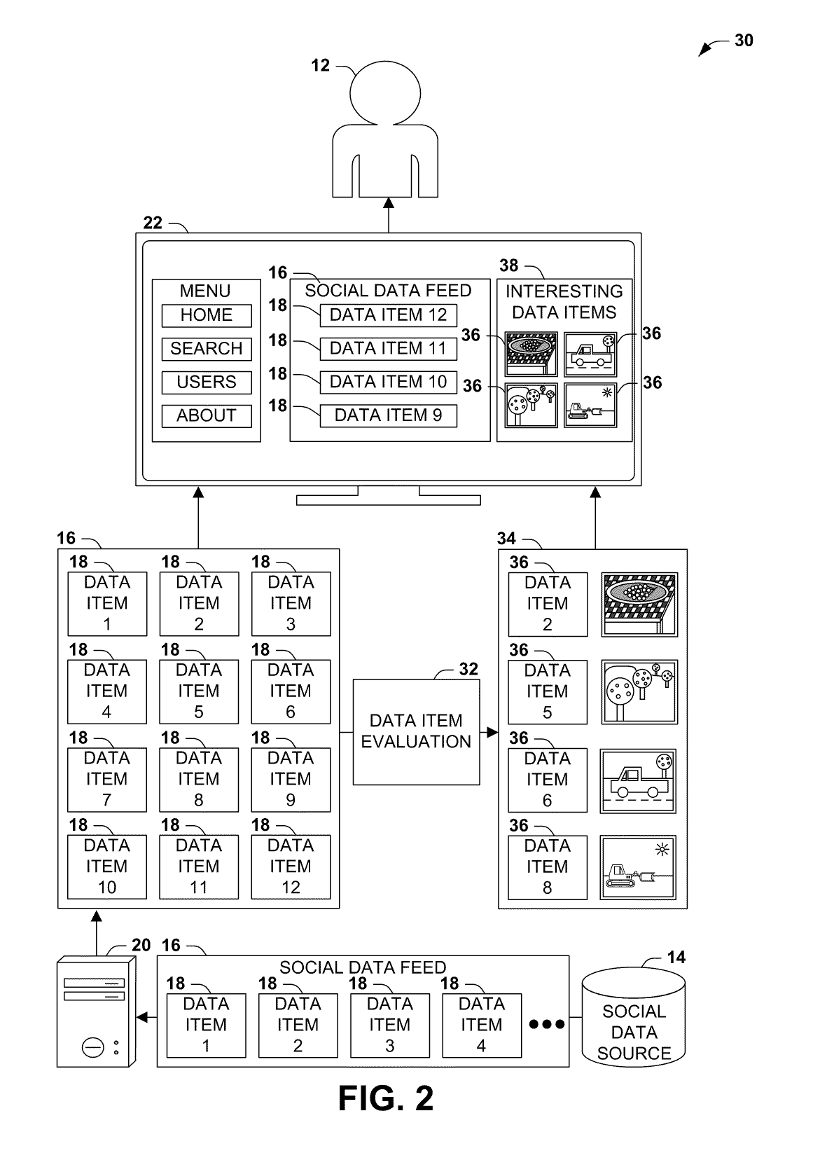

FIG. 2 presents an exemplary scenario 30 featuring a user 12 who may view a social data feed 16 on a display 22 of a device 20. Upon receiving from the user 12 a request to view the social data feed 16, the device 20 may contact the social data source 14 and retrieve the data items 18 comprising the social data feed 16. To these data items 18, the device 20 may apply a data item evaluation 32 to identify a selected data item set 34, comprising selected data items 36 that may be interesting to the user 12 (e.g., based on the popularity of the selected data items 36 among other viewers of the social data source 14; based upon commonalities of the selected data items 36 with interesting data items 24 in which the user 12 has previously expressed an interest; and/or based upon aspects of the selected data items 36 that match one or more details of a user profile of the user 12, such as details about the user's interests, location, profession, or social network.) The device 20 may then present to the user 12 on the display 22 the social data feed 16, comprising the data items 18 of the social data feed 16 that the user has chosen to view (whether all items of the social data feed 16 or only a subset thereof, such as data items 18 matching the criteria of one or more filters.) The social data feed 16 may be presented on the display 22 in a position of focus of the user 12, such as near the center of the display 22. In addition, the device 20 may present, in a peripheral region 38 with respect to the social data feed 16, the set of selected data items 36 that may be interesting to the user 12. While the user 12 is viewing the social data feed 16 presented in the position of focus, the user 12 may notice aspects of the selected data items 36 that attract his or her attention. In this manner, the user 12 may discover new interesting data items 24, even if the user 12 might not have previously indicated that such data items 18 might not be of interest. Moreover, the peripheral presentation of the selected data items 36 may exhibit a comparatively subtle presentation that does not distract the user 12 from viewing the social data feed 16, and that does not overly consume space on the display 22. These characteristics might be further promoted, e.g., by presenting the selected data items 36 in an even more peripheral or removed region of the display 22, by reducing the sizes of the selected data items 36 (such as by presenting smaller thumbnails of images), and/or by presenting the selected data items 36 with a comparatively low contrast with respect a background of the display 22 (e.g., the device 20 might reduce the contrast of images in the selected data items 36, and might shift the lightness or hue of the images toward the lightness or hue of the background), thereby reducing the vividness of the peripherally presented selected data items 36. These and other techniques for identifying and presenting potentially interesting data items 24 may be incorporated in many embodiments of these techniques in order to promote the serendipitous discovery by the user 12 of data items 18 of interest.

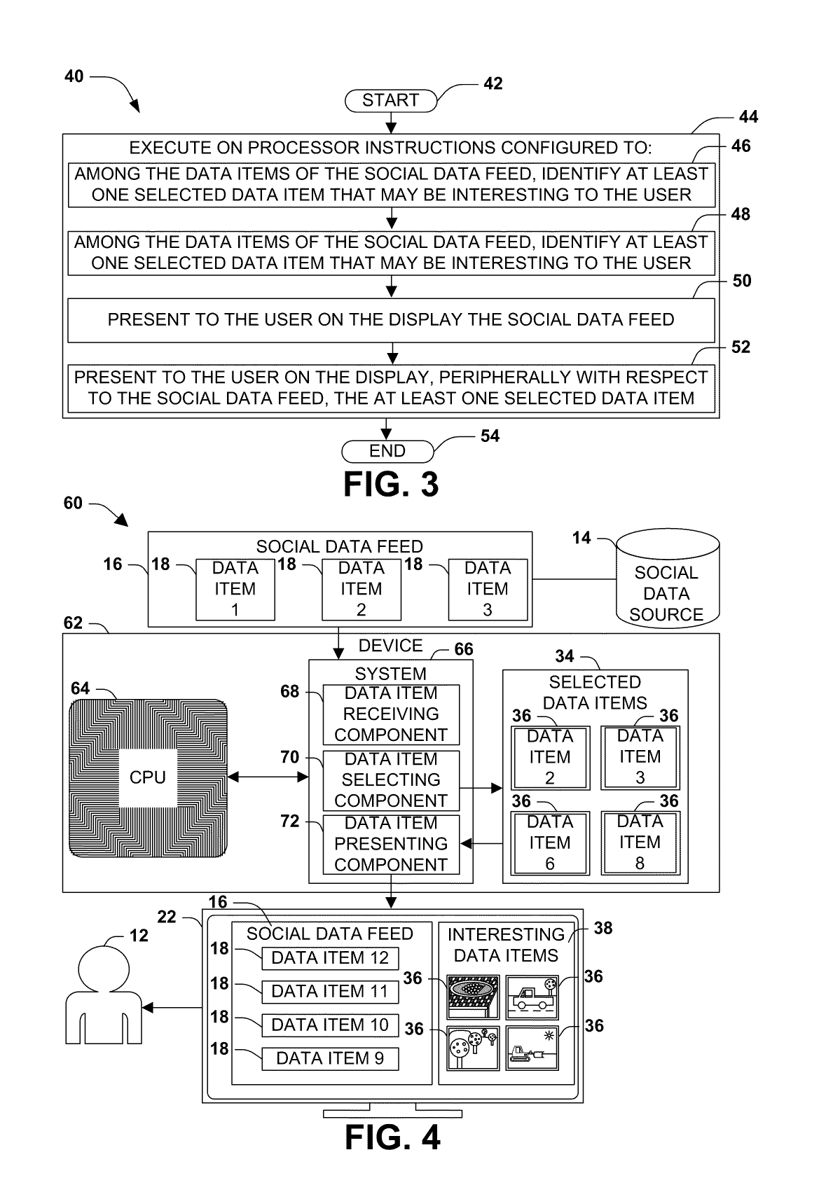

FIG. 3 presents a first embodiment of these techniques, illustrated as an exemplary method 40 of presenting to a user 12 at least one data item 18 of a social data feed 16 on a device 20 having a processor and a display 22. The exemplary method 40 may be implemented, e.g., as a set of wholly compiled, partially compiled, and/or interpreted instructions that are stored in a volatile or nonvolatile memory of the device 20. The exemplary method 40 begins at 42 and involves executing 44 on the processor instructions configured to apply the techniques presented herein. In particular, the instructions are configured to receive 46 the at least one data item 18 of the social data feed 16 from the social data source 14, and among the data items 18 of the social data feed 16, select 48 at least one selected data item 36 that may be interesting to the user 12. The instructions may also be configured to present 50 to the user 12 on the display 22 the social data feed 16, and to present 52 to the user 12 on the display 22, peripherally with respect to the social data feed 16, the at least one selected data item 36. Having achieved a peripheral presentation of the selected data items 36 in a manner that may promote serendipitous discovery of interesting data items 24 while reducing distraction of the user 12 while viewing the social data feed 16, the exemplary method ends at 54.

FIG. 4 presents a second embodiment of these techniques, illustrated as an exemplary scenario 60 featuring an exemplary system 66 configured to apply the techniques presented herein. In this exemplary scenario 60, a user 12 operates a device 62 having a processor 64 and a display 22, and having access to a social data source 14 that provides a social data feed 16 comprising one or more data items 18. The device 62 may include an exemplary system 66 embodying these techniques, which may be implemented, e.g., as a set of software instructions encoded on a volatile or nonvolatile memory of the device 62 and executed by the processor 64. Alternatively, the exemplary system 66 might comprise a set of hardware components, such as a circuit or a field-programmable gate array (FPGA) embodying logic that applies these techniques. The exemplary system 66 includes a data item receiving component 68 that is configured to receive the data items 18 of the social data feed 16 from the social data source 14. The exemplary system 66 also includes a data item selecting component 70 that is configured to, among the data items 18 of the social data feed 16, select at least one selected data item 36 that may be interesting to the user 12. The exemplary system 66 also includes a selected data item presenting component 72 that is configured to present to the user 12 on the display 22 the social data feed 16, and to present to the user 12 on the display 22, peripherally with respect to the social data feed 16, the at least one selected data item 36. In this manner, the exemplary system 66 may promote the serendipitous discovery of interesting data items 24 by the user 12 while reducing the distraction of the user 12 during the viewing of the social data feed 16.

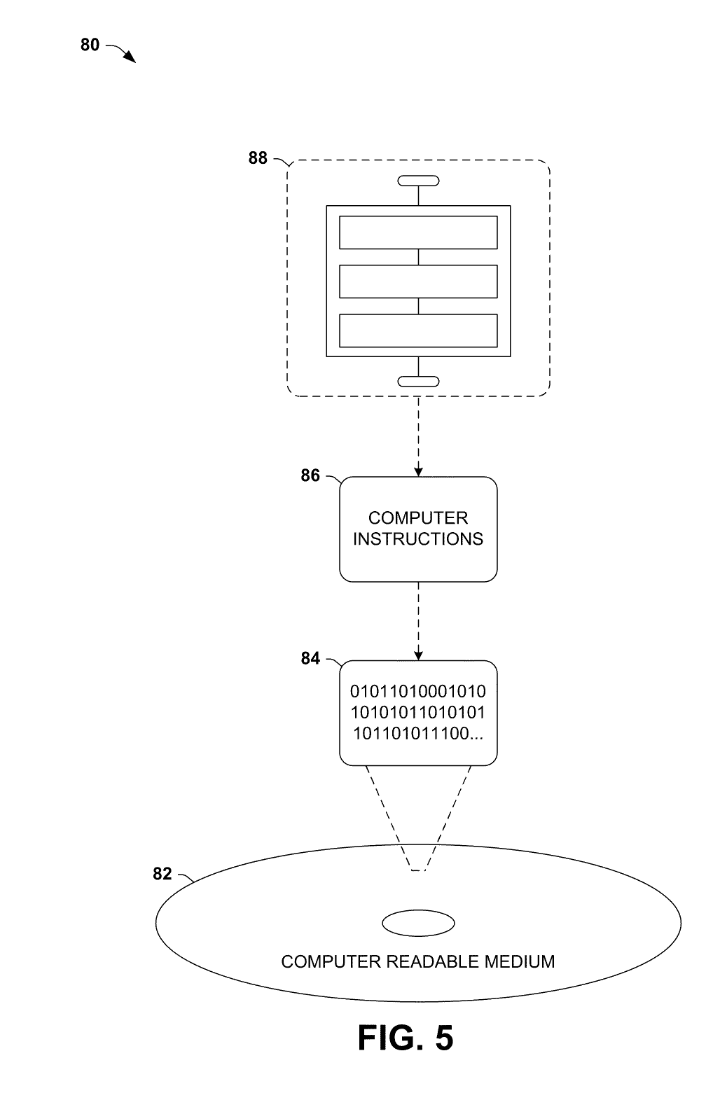

Still another embodiment involves a computer-readable medium comprising processor-executable instructions configured to apply the techniques presented herein. An exemplary computer-readable medium that may be devised in these ways is illustrated in FIG. 5, wherein the implementation 80 comprises a computer-readable medium 82 (e.g., a CD-R, DVD-R, or a platter of a hard disk drive), on which is encoded computer-readable data 84. This computer-readable data 84 in turn comprises a set of computer instructions 86 configured to operate according to the principles set forth herein. In one such embodiment, the processor-executable instructions 86 may be configured to perform a method of presenting to a user at least one data item of a social data feed, such as the exemplary method 40 of FIG. 3. In another such embodiment, the processor-executable instructions 86 may be configured to implement a system for presenting to a user at least one data item of a social data feed, such as the exemplary system 66 of FIG. 4. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 40 of FIG. 3 and the exemplary system 66 of FIG. 4) to confer individual and/or synergistic advantages upon such embodiments.

A first aspect that may vary among embodiments of these techniques relates to the scenarios wherein these techniques may be utilized. As a first example of this first aspect, these techniques may be utilized to present a set of data items 18 of a social data feed 16 stored by a social data source 14, such as a social network server. The embodiment may be utilized partly within the social data source 14, e.g., to generate and send to a device operated by the user 12 one or more web pages comprising the social data feed 16 along with peripherally presented selected data items 36, which may be rendered on a web browser or client application on the device of the user 12. The embodiment may also be utilized wholly on a device operated by the user 12; e.g., the social data source 14 may send to the user 12 a set of data items 18 for presentation, either as simple data objects (e.g., a Real Simple Syndication (RSS) data feed) or as a rendering of the social data feed 16 (e.g., as a web page embedding the data items 18), and an embodiment executing within the device of the client 12 may identify data items 18 that may be interesting to the user 12 and present them peripherally in relation to the presentation of the social data feed 16.

As a second example of this first aspect, the data items 18 might exist in one location, such as a single social data source 14 from which the data items 18 may be retrieved. Alternatively, the data items 18 might be stored on a variety of social data sources 14, and may be aggregated to generate a social data feed 16 comprising data items 18 of many types and derived from many sources. For example, the data items 18 might include weblog articles posted on the weblogs of many individuals, photos organized in albums on various photo sharing sites by individuals known to the user 12, and email messages and instant messages between the user 12 and individuals known to the user, which may be stored on a variety of devices in the form of email accounts and chat logs. In such scenarios, the use of these techniques may be even more advantageous, as the size, variety, and update frequency of the social data feed 16 may increase to unmanageable proportions.

A particular scenario wherein these techniques may be advantageously utilized involves a set of devices operated by the user 12 and forming a mesh that is configured to present to the user 12 a consistent computing environment. Recent attempts have been made to develop techniques for providing access to a computing environment among an array of devices in a consistent, deployable, and extensible manner. These techniques also seek to provide automated synchronization of data objects among all such devices, and the deployment of a common set of applications among the cooperating devices, and a centralized service for managing the procuring, installing, using, and uninstalling of applications among such devices. The set of data objects and applications is not necessarily identical among various devices; e.g., a workstation may contain a full copy of the data set and a large number of high-performance applications (e.g., photo editing software and graphically intensive games), while a cellphone device (having a smaller data store) may store only a subset of the data objects, and may feature portability applications (e.g., a GPS-based mapping software) that are not relevant to a non-portable workstation. However, many applications and data objects related thereto may be shared among such devices (e.g., a calendar application configured to manage a user calendar object), and the computing environment may be adapted to enable the distribution and synchronization of the application and data objects among such devices. It may therefore be appreciated that a computer system may be advantageously represented in a manner that enables the deployment of the computing environment among a set of devices.

In one such technique, the computing environment, including a set of applications, the application resources, and data objects used thereby (including data items 18 that may be included in a social data feed 16), is represented in a manner that may be delivered to devices for rendering according to the capabilities of the device. The objects include the data objects of the computer system, such as the user files and data created by the user, as well as representations of the myriad devices comprising the computing environment of the user. A computing environment represented in this manner may be delivered to any device and rendered in a manner suitable for the capabilities of the device. For instance, a workstation may render the information as a robust and general-purpose computing environment, while a public workstation may render a different computing environment experience through a web browser (e.g., as a virtual machine that may be discarded at the end of the user's session), and a cellphone may provide a leaner interface with quicker access to cellphone-related information (e.g., contacts, calendar, and navigation data.) Moreover, updates to the information set (e.g., preference changes and updates to data files contained therein) may be applied to the authoritative source of the information set, and thereby propagated to all other devices to which the information set is delivered.

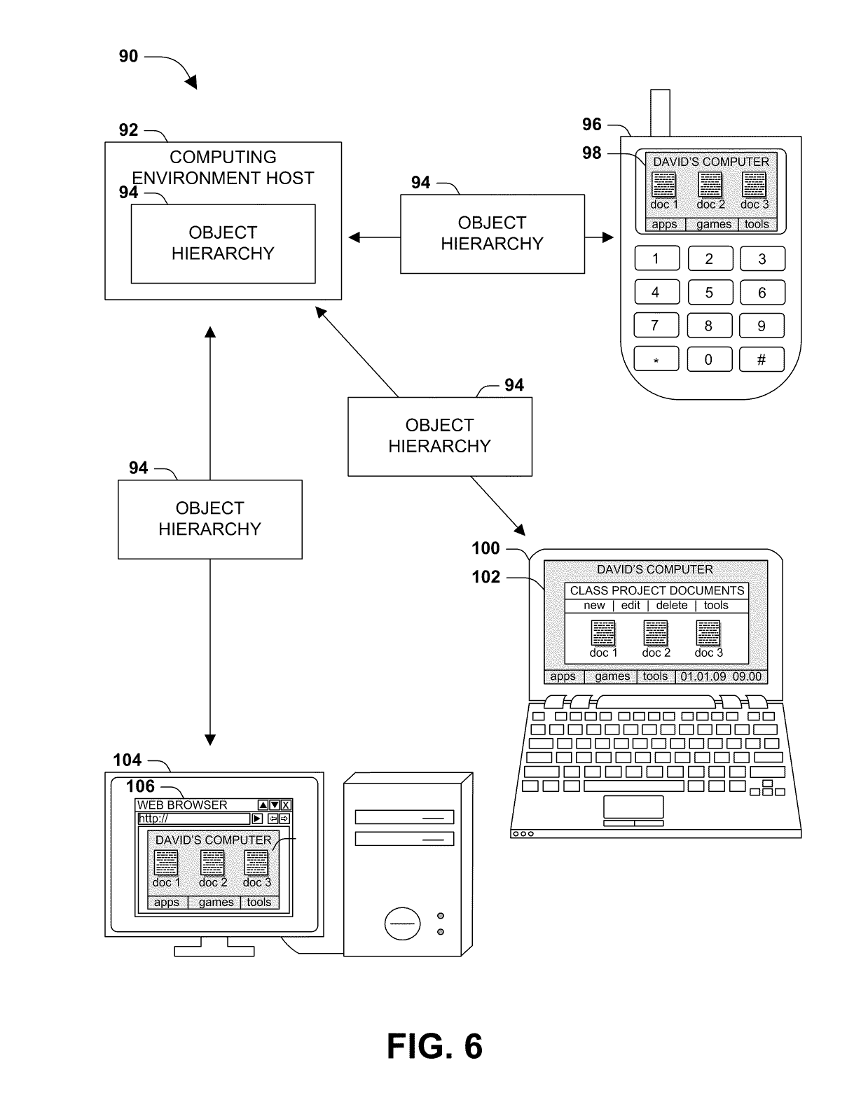

FIG. 6 illustrates one such scenario 90, wherein the computing environment may be hosted by a computing environment host 92, which may store and manage an object hierarchy 94. The computing environment host 92 may also render the object hierarchy 94 in different ways on behalf of various devices, such as a cellphone device 96, a personal notebook computer 100, and a public workstation 104, and also on behalf of different types of users having different access privileges. Updates to the computing environment may be propagated back to the computing environment host 92, and may be automatically synchronized with other devices. Hence, the computing environment may therefore be devised and presented as a cloud computing architecture, comprising a device-independent representation (a “cloud”) expressed as a consistent rendering across all devices (“clients”) that form a mesh of cooperating portals (with device-specific properties) to the same computing environment.

With respect to this exemplary scenario, some or all of the data items 18 comprising the social data feed 16 may be represented within a deployable computing environment presented by the device 62 of the user 12, and the device 62 may have to utilize the mesh in order to retrieve the data items 18 for inclusion in the social data feed 16. For example, the cellphone device 96 may store a set of text messages exchanged by the user 12 and individuals, and the personal notebook computer 100 may store a set of email messages exchanged by the user 12 and various individuals. The user 12 may then choose to view the social data feed 16 (comprising these and other data items 18) on the public workstation 104. The public workstation 104 may therefore identify within the object hierarchy 94 one or more data items 18 that may be included in the social data feed 16, and may interact with the computing environment host 92 and the other devices of the mesh to retrieve such data items 18. Moreover, the public workstation 104 may present, within a web browser 106 displayed on a display of the public workstation 104, the social data feed 16, and may also select the selected data items 36 that may be interesting the user 12 and present these selected data items 36 peripherally with respect to the social data feed 16. Those of ordinary skill in the art may devise many scenarios wherein the techniques presented herein might be advantageously utilized.

A second aspect that may vary among embodiments of these techniques relates to the manner of identifying data items 18 of the social data feed 16 that might be interesting to the user 12. As a first example of this second aspect, particular data items 18 that are generally interesting may be presented to the user 12, such as data items 18 that are popular to many users 12, or data items 18 of a particular data type that often incites more interest than other data types; e.g., image data items 18 might be considered more popular than textual data items 18, and might therefore be more often selected for peripheral presentation. As a second example of this second aspect, particular data items 18 might be selected by identifying at least one topic that may be interesting to the user 12, and then identifying for selection at least one data item 18 that is associated with the at least one interesting topic. The interest of the user 12 in a topic might be inferred, e.g., based on some user actions of the user 12. As one such example, the user 12 might spend more time interacting with a particular data item 18 that with other data items 18 of the social data feed 16, such as by viewing the data item 18 longer, or viewing a particular data item 18 in its entirety (e.g., scrolling the entire way through a long textual data item 18.) An embodiment of these techniques may detect the user interest in the data item 18, may identify a topic related to the data item 18, and may select for peripheral presentation other data items 18 that involve the same topic. As another such example, the user 12 might be associated with a user profile that describes various aspects of the user 12, such as the location, profession, and personal interests of the user 12. An embodiment of these techniques may therefore identify topics that may be interesting to users 18 sharing such aspects of the user profile, and may select for peripheral presentation various data items 18 that relate to such topics. As yet another example, data items may only be selected that have not been presented (concurrently or previously) to the user 12 as data items 18 in the social data feed 16, and/or that have not previously been peripherally presented to the user 12. This criterion for selecting data items may promote the freshness of selected data items 36 in the peripheral presentation, which may promote user attention to the peripheral presentation.

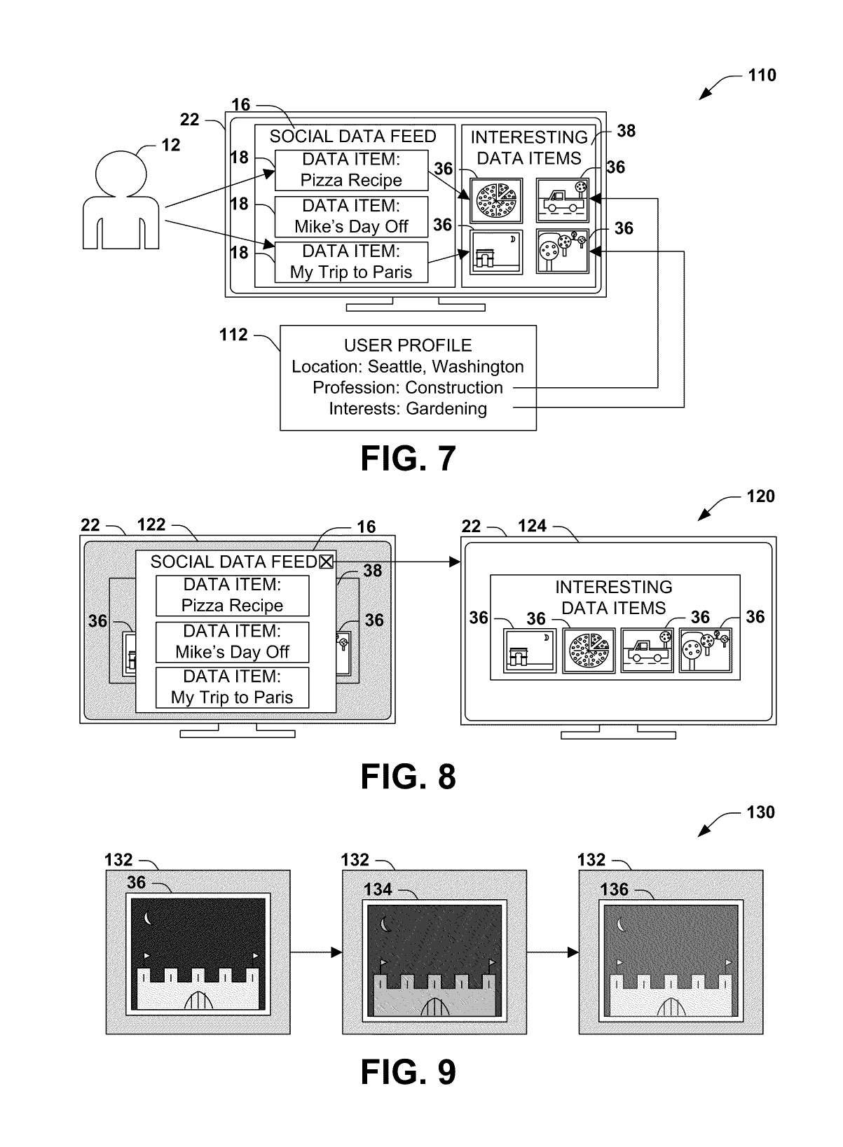

FIG. 7 presents an exemplary scenario 110 involving a selection of data items 18 for peripheral presentation that may be interesting to a user 12 based on some of these techniques. The social data feed 16 comprises a set of data items 18 (e.g., a combination of textual anecdotes and photos) submitted by individuals known to the user 12. As a first example, the user 12 may spend some time interacting with various data items 18, and an embodiment of these techniques may utilize this interaction to identify some of these data items 18 as interesting to the user 12. The embodiment might endeavor to identify one or more topics involved in such data items 18, and might therefore select and peripherally present other data items 18 from the social data feed 16 that relate to such topics. In particular, the embodiment might select images, including photos, that might be more effectively to present peripherally to the user 12. As a first such technique, the user 12 might spend some time reviewing a pizza recipe, and an embodiment of these techniques might select an image of a pizza for display in a peripheral region 38 of the display 22; similarly, the user 12 might spend time reading an anecdote about a trip to Paris, and a photo of a landmark in Paris might be selected and peripherally presented. It may be additionally advantageous to present such data items 36 peripherally but in relation to the data items 18 of the social data feed 16 in which the user 12 has expressed an interest; e.g., the photo of a pizza may be presented peripherally but in approximate vertical alignment with the data item 18 comprising a pizza recipe, and the photo of a Paris landmark may be presented peripherally but in approximate vertical alignment with the data item 18 comprising an anecdote about a trip to Paris. Other techniques for illustrating the topical association of data items 18 presented at a position of focus in the social data feed 16, and selected data items 36 presented in the peripheral region 38, e.g., displaying a line connecting the data items 18 that leads the user's eye from the data item 18 of interest to the peripherally presented data item 18 involving the same topic.

FIG. 7 also illustrates a second technique for selecting data items 18 for peripheral presentation on the display 22 with respect to the social data feed 16. Potentially interesting data items 24 might be identified based on information about the user 12 contained in a user profile 112, identifying topics that may be interesting to the user 12 based on this information, and then identifying data items 18 for peripheral presentation that are associated with such topics. For example, if the user profile 112 indicates that the user 12 is employed in the profession of construction, an embodiment of these techniques may select a photo of a construction truck as a potentially interesting data item 24, and may present this selected data item 36 in the peripheral region 38 of the display 22; and if the user profile 112 indicates that the user 12 engages in gardening as an interest, the embodiment may select a photo of an orchard as a selected data item 36 for presentation in the peripheral region 38 of the display 22. Those of ordinary skill in the art may devise many techniques for identifying potentially interesting data items 24 of a social data feed 16 to be peripherally presented to the user 12 while implementing the techniques discussed herein.

A third aspect that may vary among embodiments of these techniques relates to the manner of presenting the selected data items 36 of the social data feed 16 to the user 12. As a first example of this third aspect, the selected data items 36 may be presented peripherally with respect to the social data feed 16 in many ways. In one such embodiment, the selected data items 36 may be presented concurrently with the social data feed 16 and in a peripheral region of the display 22, such as to the left, right, above, or below the position of focus wherein the social data feed 16 is displayed. However, the “peripheral” presentation might also include presenting the interesting data items 36 before or after the social data feed 16, in a manner that the user 12 may peripherally notice without being overly distracted from the presentation of the social data feed 16 in the position of focus. For example, the interesting data items 36 may be presented behind the social data feed 16, or may be presented before or after the presentation of the data feed 16, such as a transitional presentation of the selected data items 36 for a brief period before presenting the social data feed 16.

FIG. 8 illustrates an exemplary scenario 120 featuring an alternative peripheral presentation of the selected data items 36 in accordance with this first variation of the third aspect. In a first presentation 122 on the display 22, an embodiment of these techniques may present the social data feed 16, but may present the selected data items 36 in a separate window or tab behind the social data feed 16, which may catch the user's eye without overly distracting from the social data feed 16. Moreover, when the user closes, minimizes, hides, or otherwise relocates the social data feed 16, the selected data items 36 rendered behind or underneath the social data feed 16 may be displayed. In this manner, the user 12 may be peripherally exposed to the interesting data items 36 while reducing the distraction of the user 12 from the social data feed 16.

As a second example of this third aspect, the peripheral presentation may be arranged in many ways, and some arrangements may be more advantageous than other arrangements. Various aesthetic and user-interface considerations may motivate the selection of one arrangement over another. For example, a clustering of selected data items 36 of similar types may present a more orderly or compact peripheral presentation than a more mixed presentation of selected data items 36; e.g., the selected data items 36 may be clustered as images, textual items, and videos, rather than a mixed set of selected data items 36. As another example, it may be desirable to present the selected data items 36 in a similar manner to the presentation of the data items 18 of the social data feed 16, rather than with a different arrangement that might be distracting. The exemplary scenario 110 of FIG. 7 illustrates yet another example, where a set of images may be peripherally presented as a tiled grid, such as a tiled thumbnail set, where the thumbnails are scaled to approximately the same size in order to render a clean, organized peripheral presentation of the selected data items 36. Similarly, excerpts of textual data items may be extracted with approximately the same amount of text, such that excerpts may be organized into a column with approximately the same width for each selected selected data item 36.

As a third example of this third aspect, the peripheral presentation of the selected data items 36 may be designed to reduce the degree of distraction of the user 12 from the social data feed 16. It may be appreciated that, if the selected data items 36 are presented in too noticeable a manner (e.g., by taking up too much of the display 22, with vivid colors, or with animation that is difficult to disregard), the user interface may appear “noisy,” and the user 12 may become irritated by the attention-diverting presentation of content other than the social data feed 16 that the user 12 has requested to view. A first embodiment of this third example might adjust the location, size, and appearance of a peripheral region 38 wherein selected data items 36 may be presented. For example, the peripheral region 38 may be positioned close enough to the social data feed 16 that it does not appear unrelated, but may be positioned distantly enough as to remain in the peripheral view of the user 12 and not intrude on the position of focus occupied by the social data feed 16.

A second embodiment of this third example of this third aspect might present to the user 12 on the display 22, peripherally with respect to the social data feed 16, the selected data items 36 in low contrast with a background of the display (such as the background of a web page or application upon which the selected data items 36 are presented, or the background of a desktop environment presented on the display 22.) For example, images may be adjusted to reduce vivid colors and noisy details that might distract the user 12 by clashing with the background of the display 22. In this manner, the distracting effect of the selected data items 36 may be reduced, while still conveying aspects of the selected data items 36 that may be interesting to the user 12.

FIG. 9 presents an exemplary scenario 130 featuring a reducing of contrast of a selected data item 36 for presentation against a background 132 of the display 22. The selected data item 36 might comprise, e.g., a photo of a night scene presenting significant contrast, both within the image and as portrayed against the background 132, and a peripheral presentation of this selected data item 36 may be too distracting to the user 12. In order to reduce the distraction of the user 12, the selected data item 36 may be adjusted by reducing the contrast within the image (e.g., to produce a first representation 134 of the selected data item 36 that reduces the brightness of light colors and increases the darkness of dark colors), and/or by adjusting the lightness or hue of the image toward the color of the background 132 (e.g., the light level of the first representation 134 may be significantly darker than the background 132, so the first representation 134 may be lightened to produce a second representation 136 of the selected data item 36.) The adjusted selected data item 36 may then be peripherally presented to the user 12 with respect to the social data feed 16, thereby reducing the distraction of the user by the selected data item 36 while viewing the social data feed 16.

A third embodiment of this third example of this third aspect might present to the user 12 on the display 22, peripherally with respect to the social data feed 16, a preview representation of respective selected data items 36, e.g., a thumbnail version of an image, a representative screenshot of a video, or an excerpt of a textual data item. The user 12 may interact with the preview representation (e.g., by clicking on a thumbnail of an image with a pointing device) to view the full representation of the selected data item 36. The displaying of preview representations may reduce the amount of display space involved in peripherally presenting the selected data items 36, and/or may reduce the attention-diverting nature of such selected data items 36 (e.g., by presenting a static screenshot of a video instead of presenting an animating video that may be difficult to disregard.) However, the scaling of the selected data items 36 may be carefully selected, e.g., to reduce the display space consumed by such presentation, while also permitting the preview representations to retain a level of detail that easily suggests the topics included in the selected data item 36 (e.g., an image may be scaled down to a thumbnail representation to reduce the display space consumed by displaying the thumbnail representation, but not scaled down so that the interesting aspects of the image are not easily noticeable in the thumbnail representation.)

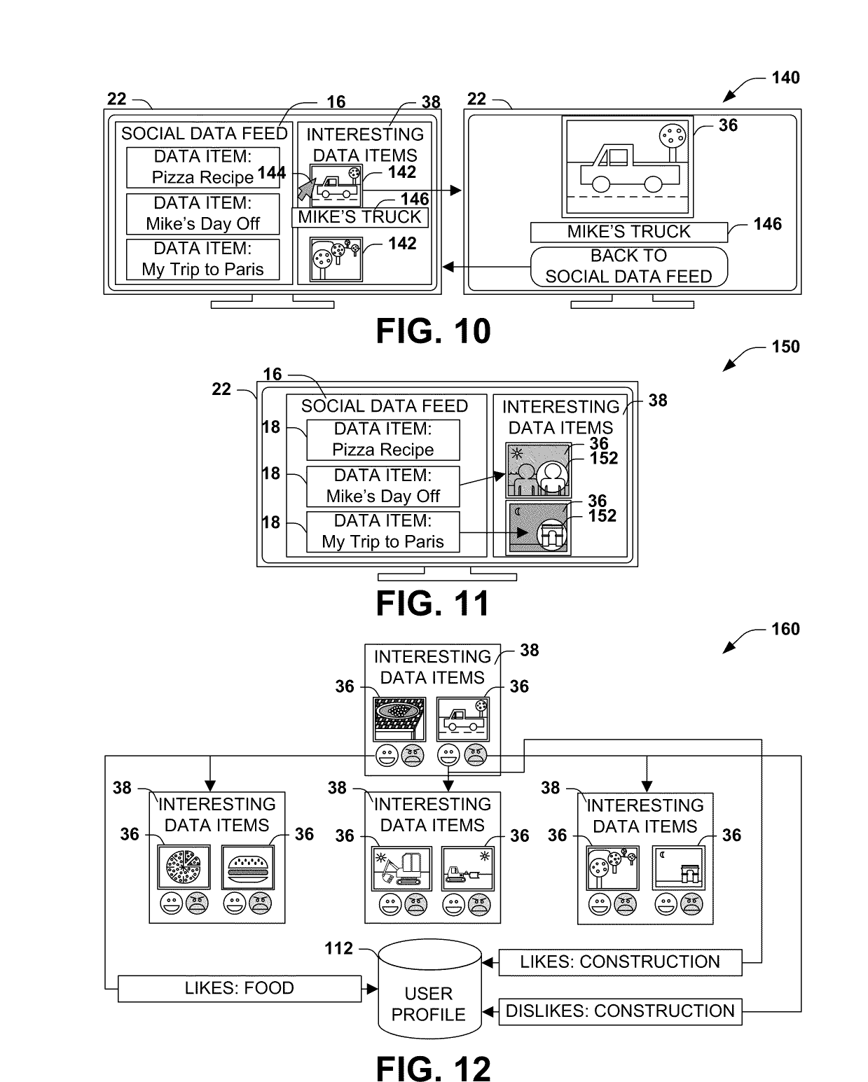

FIG. 10 presents an exemplary scenario 140 featuring a peripheral presentation of selected data items 36 as preview representations. This exemplary scenario 140 features a social data feed 16 that is presented on the display 22 in a position of focus, e.g., near the center of the screen, and a peripheral presentation of selected data items 36 that may be interesting. However, the selected data items 36 may comprise images that are too large to display conveniently in the peripheral presentation, and that may distract the user 12 from the social data feed 16 if presented in full resolution. Rather, the selected data items may be rendered as a set of preview representations 142, e.g., thumbnail versions of the images. Moreover, when the user 12 selects a preview representation 142 (e.g., by clicking on the preview representation 142 with a cursor 144 operated by a pointing device), the full version of the selected data item 36 may be presented to the user 12 until the user 12 wishes to return to the presentation of the social data feed 16.

A fourth example of this third aspect relates to the presentation of information related to the selected data items 38 while peripherally presenting the selected data items 38 with respect to the social data feed 16. The information about a data item 18 may be as interesting to the user 12 as the actual data item 18; however, presenting too much information with the selected data items 36 may cause the peripheral presentation to become too distracting or to consume too much display space. Therefore, it may be desirable to present the additional information in a consolidated manner that does not significantly increase the size of the peripheral presentation. A first embodiment of this fourth example may endeavor to position a selected data item 36 within the peripheral presentation near one or more data items 18 of the social data feed 16, e.g., in approximate horizontal alignment with the data item 18, such as in the exemplary scenario 110 of FIG. 7. Alternately, this association may be subtly displayed in other ways, e.g., with a visual indication (such as a dashed line) connecting a data item 18 in the social data feed 16 with one or more related selected data items 36 in the peripheral presentation.

A second embodiment of this fourth example of the third aspect involves the presentation of metadata items with the selected data items 36 in a manner that does not significantly add to the amount of information in the peripheral presentation. In this embodiment, a metadata item associated with a selected data item 36 may be hidden until detecting a user selection of a selected data item 36, e.g., by hovering over or near the selected data item 36 with a pointing device. Metadata items associated with the selected data item 36 may then be displayed (e.g., as a pop-up descriptor near the selected data item 36) until the user 12 loses interest, e.g., by moving the pointing device away from the selected data item 36. FIG. 10 illustrates this technique within the exemplary scenario 140 presented therein, where, upon selecting (e.g., with a cursor 144 operated by a pointing device) the preview representation 142 of a selected data item 36, a metadata item 146 may be displayed near the selected data item 36 (such as a text caption), until the user 12 moves the cursor 144 away from the preview representation 142. The metadata item 146 may also be presented, e.g., with the full version of the selected data item 36 if the user 12 otherwise selects the preview representation 142 (e.g., by clicking on the preview representation 142 with the cursor 144.)

A third embodiment of this fourth example of this third aspect involves a highlighting a content item of a selected data item 36 that may be interesting to the user 12 (e.g., the information that prompted the selection of the selected data item 36.) For example, a textual data item may include a keyword that might be interesting to the user 12, and that may have prompted the selection of the data item 18; accordingly, the keyword may be highlighted when the selected data item 18 is displayed in the peripheral presentation. As another example, an image may depict a subject of interest to the user 12 (e.g., an individual, building, or item in which the user 12 may be interested), and the topic may be highlighted in the image during the peripheral presentation.

FIG. 11 presents an exemplary scenario 150 featuring this technique. In this exemplary scenario 150, a social data feed 16 is displayed on a display 22 in a position of focus, while a set of selected data items 36 that may be interesting to the user 12 is displayed in a peripheral region 38 of the display 22 with respect to the social data feed 16. The first selected data item 36 may have been selected because the user 18 may have shown interest in a first data item 18 (e.g., an anecdote by a particular individual), and the first selected data item 36 may comprise a photo representing this anecdote. Moreover, the user 12 may be interested in the individual, and the first selected data item 36 may include the individual (as a content item) in the photo. Accordingly, highlighting 152 may be applied to the image, such as a dimming of the photo with a “spotlight” effect applied to the content item. Similarly, the user 12 may have expressed interest in a data item 18 comprising an anecdote relating to a trip to Paris, and when a photo of a Paris landmark (perhaps mentioned in the anecdote) is selected for peripheral presentation, highlighting 152 may be applied to the selected data item 36 to draw the attention of the user 12 to the content item that the user 12 might find interesting.

A fourth embodiment of this fourth example of this third aspect may adjust the presentation of the selected data items 36 to avoid redundant presentation with the social data feed 16, and/or with previous peripheral presentations of selected data items 36. For example, if a selected data item 36 has previously been presented (or even viewed) by the user 12, if it is subsequently selected again for peripheral presentation, the selected data item 36 may be presented with a visual indicator thereof, e.g., by displaying the background of the selected data item 36 in a different color than the other selected data items 36 that have not previously been presented, or by display such selected data items 36 below newly selected data items 36. This adjustment may, e.g., give the user 12 a second chance to view such selected data items 36, and may allow the user 12 to disregard selected data items 36 that have been previously presented and to limit his or her attention to newly selected data items 36. Those of ordinary skill in the art may devise many ways of presenting to the user 12, peripherally with relation to the social data feed 16, the selected data items 36 that may be interesting to the user 12 in accordance with the techniques discussed herein.

A fourth aspect that may vary among embodiments of these techniques relates to various types of user interaction of the user 12 with the data items 18 of the content data feed 16, and/or with peripherally presented selected data items 36, that may promote subsequent selection and peripheral presentation of other selected data items 36 that may be interesting to the user 12. The exemplary scenario 140 of FIG. 10 presents two such interactions, where the user 12 may select a selected data item 36 in order to view one or more metadata items 146, and/or in order to view a full representation of a selected data item 36 that is peripherally presented as a preview representation 142 (such as a thumbnail.)

As a second example of this fourth aspect, an embodiment may allow the user 12 to express an interest in a particular topic, and may subsequently endeavor to select data items 18 for peripheral presentation that relate to the selected topic. In one such embodiment, data items 18 in the social data feed 16 and/or selected data items 36 in the peripheral presentation may include controls for permitting the user 12 to request more or fewer data items 18 of a particular kind, and the subsequent selection of data items 18 for peripheral presentation may be accordingly adjusted. For example, upon receiving from the user 18 a request for more data items 18 that are similar to an indicated data item, an embodiment may select at least one similar data item 18 of the social data feed 16 that is similar to the indicated data item, and may include the at least one similar data item in the peripheral presentation. Alternatively or additionally, upon receiving from the user 12 a request for fewer data items 18 that are similar to an indicated data item, an embodiment may select similar data items that are similar to the indicated data item, and may remove from peripheral presentation the selected data item and the at least zero similar data items 18. In either technique, the identification of “similar” data items 18 to the indicated data item might be performed in many ways, e.g., identifying at least one metadata item 146 of the indicated data item that may have prompted the request of the user 12, and by selecting at least one similar data item 18 having the metadata item 146. Additionally, the embodiment might perform this inclusion promptly, e.g., by promptly identifying similar data items and automatically adding to or removing from the peripheral presentation the similar data items. Alternatively, the embodiment may store the metadata items 146 in association with the user 12 (e.g., in a user profile) as indications of the types of data items 18 that the user 12 finds interesting or not interesting, and may adjust future peripheral presentations accordingly. For example, upon identifying the at least one metadata item 146 that may have prompted the request for more or fewer data items 18 that are similar to the indicated data item, an embodiment may store the at least one metadata item 146 associated with the user 12, and may subsequently select data items 18 for peripheral presentation by retrieving the at least one metadata item 146 selecting (or not selecting) data items 18 having the at least one metadata item 146.

FIG. 12 presents an exemplary scenario 160 featuring the inclusion of controls for permitting the user 12 to indicate whether a selected data item 36 is or is not of interest. In this exemplary scenario 160, each selected data item 36 includes a set of user controls indicating that the selected data item 36 is interesting or is not interesting. Selecting the “interesting” control for the first data item 36 (depicting a type of food) may result in a selection of additional data items 36 depicting different types of food, which may be promptly added to the peripheral presentation and/or may be selected for subsequent peripheral presentations of selected data items 36. By contrast, selecting the “interesting” control for the second selected data item 36 (depicting a construction vehicle) may cause the embodiment to include, in the current peripheral presentation and/or subsequent peripheral presentations, additional photos of construction vehicles. Conversely, selecting the “not interesting” control for the second selected data item 36 may cause the removal and/or avoidance of data items 18 depicting construction vehicles from peripheral presentation; e.g., the second selected data item 36 may be promptly removed from peripheral presentation and may be replaced with other selected data items 36 depicting other topics, and future selection of data items 18 for peripheral presentation may exclude similar pictures of construction vehicles. For example, the selection by the user 12 of topics or data items that are (or are not) of interest may be stored, e.g., in a user profile 112 of the user 12, in order to promote the future selection of data items 18 for peripheral presentation. Those of ordinary skill in the art may devise many ways of permitting the user 12 to interact with the peripheral presentation of selected data items 36 in order to promote the selection and peripheral presentation of interesting data items 24 in accordance with the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

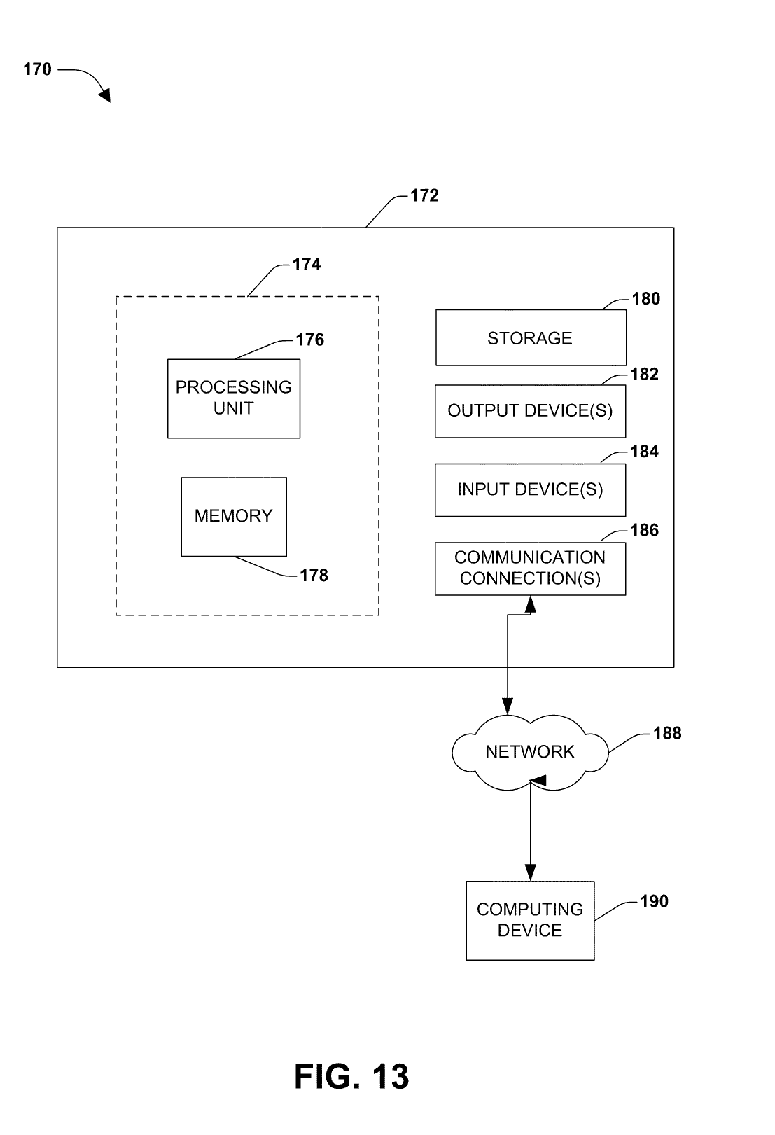

FIG. 13 and the following discussion provide a brief, general description of a suitable computing environment to implement embodiments of one or more of the provisions set forth herein. The operating environment of FIG. 13 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 13 illustrates an example of a system 170 comprising a computing device 172 configured to implement one or more embodiments provided herein. In one configuration, computing device 172 includes at least one processing unit 176 and memory 178. Depending on the exact configuration and type of computing device, memory 178 may be volatile (such as RAM, for example), non-volatile (such as ROM, flash memory, etc., for example) or some combination of the two. This configuration is illustrated in FIG. 13 by dashed line 174.

In other embodiments, device 172 may include additional features and/or functionality. For example, device 172 may also include additional storage (e.g., removable and/or non-removable) including, but not limited to, magnetic storage, optical storage, and the like. Such additional storage is illustrated in FIG. 13 by storage 180. In one embodiment, computer readable instructions to implement one or more embodiments provided herein may be in storage 180. Storage 180 may also store other computer readable instructions to implement an operating system, an application program, and the like. Computer readable instructions may be loaded in memory 178 for execution by processing unit 176, for example.

The term “computer readable media” as used herein includes computer storage media. Computer storage media includes volatile and nonvolatile, removable and non-removable media implemented in any method or technology for storage of information such as computer readable instructions or other data. Memory 178 and storage 180 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 172. Any such computer storage media may be part of device 172.

Device 172 may also include communication connection(s) 186 that allows device 172 to communicate with other devices. Communication connection(s) 186 may include, but is not limited to, a modem, a Network Interface Card (NIC), an integrated network interface, a radio frequency transmitter/receiver, an infrared port, a USB connection, or other interfaces for connecting computing device 172 to other computing devices. Communication connection(s) 186 may include a wired connection or a wireless connection. Communication connection(s) 186 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 172 may include input device(s) 184 such as keyboard, mouse, pen, voice input device, touch input device, infrared cameras, video input devices, and/or any other input device. Output device(s) 182 such as one or more displays, speakers, printers, and/or any other output device may also be included in device 172. Input device(s) 184 and output device(s) 182 may be connected to device 172 via a wired connection, wireless connection, or any combination thereof. In one embodiment, an input device or an output device from another computing device may be used as input device(s) 184 or output device(s) 182 for computing device 172.

Components of computing device 172 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 172 may be interconnected by a network. For example, memory 178 may be comprised of multiple physical memory units located in different physical locations interconnected by a network.

Those skilled in the art will realize that storage devices utilized to store computer readable instructions may be distributed across a network. For example, a computing device 190 accessible via network 188 may store computer readable instructions to implement one or more embodiments provided herein. Computing device 172 may access computing device 190 and download a part or all of the computer readable instructions for execution. Alternatively, computing device 172 may download pieces of the computer readable instructions, as needed, or some instructions may be executed at computing device 172 and some at computing device 190.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting to a user at least one data item of a social data feed on a device having a processor and a display, the method comprising:
executing on the processor instructions configured to:
receive the at least one data item of the social data feed from the social data source;
among the data items of the social data feed, select at least one selected data item that may be interesting to the user;
present to the user on the display the social data feed; and
present to the user on the display, peripherally with respect to the social data feed, the at least one selected data item.

2. The method of claim 1, the data items represented within a deployable computing environment presented on the device.

3. The method of claim 1, the social data feed comprising a first data item retrieved from a first social data source and a second data item retrieved from a second social data source.

4. The method of claim 1, selecting the at least one selected data item comprising:
identifying at least one topic that may be interesting to the user, and
selecting at least one selected data item associated with the at least one topic.

5. The method of claim 1, selecting the at least one selected data item comprising: selecting at least one selected data item that may be interesting to the user and that has not been presented to the user.

6. The method of claim 1, presenting on the display the at least one selected data item comprising: present to the user on the display the at least one selected data item in a peripheral region of the display with respect to the social data feed.

7. The method of claim 1, presenting on the display the at least one selected data item comprising: presenting to the user on the display, peripherally with respect to the social data feed, a preview representation of the at least one selected data item.

8. The method of claim 7, the instructions configured to: upon detecting a user selection of at least one preview representation of a selected data item, present to the user on the display the selected data item.

9. The method of claim 1, peripherally presenting on the display the at least one selected data item comprising: presenting to the user on the display, peripherally with respect to the social data feed, the at least one selected data item, respective selected data items comprising at least one highlighting of at least one content item that may be interesting to the user.

10. The method of claim 1:
the at least one data item comprising an image, and
presenting the images to the user on the display comprising: presenting to the user on the display, peripherally with respect to the social data feed, a tiled thumbnail set comprising thumbnail representations of the at least one image.

11. The method of claim 1:
at least one selected data item associated with a metadata item, and
the instructions configured to, upon detecting a user selection of a selected metadata item, present to the user on the display the metadata item associated with the selected data item.

12. The method of claim 1, presenting on the display the at least one selected data item comprising: presenting on the display, peripherally with respect to the social data feed, the at least one data item in low contrast with a background of the display.

13. The method of claim 1, the instructions configured to, upon receiving from the user a request for more data items that are similar to an indicated data item:
select at least one similar data item that is similar to the indicated data item, and
present to the user on the display, peripherally with respect to the social data feed, the at least one similar data item.

14. The method of claim 13, selecting the at least one similar data item that is similar to the indicated data item comprising:
identifying at least one metadata item of the indicated data item that may have prompted the request, and
selecting at least one similar data item having the metadata item.

15. The method of claim 14:
the instructions configured to, upon identifying the at least one metadata item that may have prompted the request, store the at least one metadata item associated with the user; and
subsequently selecting at least one data item that may be interesting to the user comprising:
retrieving the at least one metadata item, and
selecting the at least one selected data item having the at least one metadata item.

16. The method of claim 1, the instructions configured to, upon receiving from the user a request for fewer data items that are similar to an indicated data item:
select at least zero similar data items that are similar to the indicated data item, and
remove from peripheral presentation the selected data item and the at least zero similar data items.

17. The method of claim 16, selecting the at least one similar data item that is similar to the indicated data item comprising:
identifying at least one metadata item of the indicated data item that may have prompted the request, and
selecting at least one similar data item having the at least one metadata item.

18. The method of claim 17:
the instructions configured to, upon identifying the at least one metadata item that may have prompted the request, store the at least one metadata item associated with the user; and
subsequently selecting at least one data item that may be interesting to the user comprising:
retrieving the at least one metadata item, and
selecting at least one selected data item not having the at least one metadata item.

19. A system configured to present to a user at least one data item of a social data feed on a device having a display, the system comprising:
a data item receiving component configured to receive the at least one data item of the social data feed from the social data source;
a data item selecting component configured to, among the data items of the social data feed, select at least one selected data item that may be interesting to the user; and
a selected data item presenting component configured to:
present to the user on the display the social data feed, and
present to the user on the display, peripherally with respect to the social data feed, the at least one selected data item.

20. A computer-readable nontransient storage medium comprising instructions that, when executed on a processor of a device having a display, present to a user of the device a social data feed comprising a first data item retrieved from a first social data source and a second data item retrieved from a second social data source by:
receiving at least one data item of the social data feed from the first social data source;
receiving at least one data item of the social data feed from the second social data source;
among the data items of the social data feed, selecting at least one selected data item that may be interesting to the user by:
identifying at least one topic that may be interesting to the user, and
selecting at least one selected data item comprising an image and associated with a metadata item and the at least one topic, and that has not been presented to the user;
presenting to the user on the display the social data feed;
presenting to the user on the display, in a peripheral region of the display with respect to the social data feed, a tiled thumbnail set comprising thumbnail representations of the at least one image in low contrast with a background of the display, respective images comprising at least one highlighting of at least one content item that may be interesting to the user;
upon detecting a user selection of at least one thumbnail representation of a selected data item, presenting to the user on the display the selected data item and the at least one metadata item associated with the image;
upon receiving from the user a request for more data items that are similar to an indicated data item:
selecting at least one similar data item that is similar to the indicated data item by:
identifying at least one metadata item of the indicated data item that may have prompted the request, and
selecting at least one similar data item having the metadata item, and
presenting to the user on the display, peripherally with respect to the social data feed, the at least one similar data item;
upon receiving from the user a request for fewer data items that are similar to an indicated data item:
selecting at least zero similar data items that are similar to the indicated data item by:
identifying at least one metadata item of the indicated data item that may have prompted the request, and
selecting at least zero similar data items having the at least one metadata item;
removing from peripheral presentation the selected data item and the at least zero similar data items.
